(19) United States
(12) Patent Application Publication
(10) Pub. No.: US 2008/0240844 A1
(43) Pub. Date: Oct. 2, 2008

(54) Document tray

(76) Inventors: Mark E. Fastabend, Chicago, IL (US); Iulius Lucaci, Evanston, IL (US); Kurt Sward, Deerfield, IL (US); Evan Ward, Chicago, IL (US); Craighton Berman, Chicago, IL (US)

Correspondence Address: MCDERMOTT, WILL & EMERY LLP, 227 WEST MONROE STREET, SUITE 4400, CHICAGO, IL, 60606-5096, US

(21) Appl. No.: 11/728,585

(22) Filed: Mar. 26, 2007

(51) Int. Cl. B42F 13/02

(52) U.S. Cl. 402/77

(57) ABSTRACT

The present invention generally provides a document tray to retain a writing surface and provide for annotation over a majority of the writing surface. The document tray generally combines a generally planar rigid backer member and a frame holder connected to the backer member. The frame holder has a plurality of side components positioned in a plane generally parallel to and spaced from the backer member to define a document recess. The document is thus retained in the document recess.

### CROSS-REFERENCE TO RELATED APPLICATIONS

Not Applicable.

### FEDERALLY SPONSORED RESEARCH OR DEVELOPMENT

Not Applicable.

### TECHNICAL FIELD

The present invention relates generally to a document tray, and more specifically to a document tray used in connection with portfolios, planners, calendars and other record maintaining systems.

### BACKGROUND OF THE INVENTION

Portfolios, planners, calendars and other record maintaining systems are well known in the art. While such systems according to the prior art individually provide a number of advantageous features, they nevertheless have certain limitations. The present invention seeks to overcome certain of these limitations and other drawbacks of the prior art, and to provide new features not heretofore available. A full discussion of the features and advantages of the present invention is deferred to the following detailed description, which proceeds with reference to the accompanying drawings.

### SUMMARY OF THE INVENTION

The present invention generally provides a document tray for a portfolio, planner, calendar or other record maintaining system. The document tray generally comprises a generally planar rigid backer member and a frame holder connected to the backer member. A recess is provided between the frame holder to allow the user to write on a document when it is retained in the document tray.

According to one embodiment, the frame holder has a first side component, a second side component opposing the first side component, and a third side component between the first side component and the second side component. A portion of the frame holder is positioned in a plane generally parallel to the backer member to define a document recess frame. An opening in the frame defines a document recess.

According to another embodiment, the frame holder has a fourth side component opposing the third side component. The fourth side component is between the first side component and the second side component. In one embodiment of the four-sided frame the fourth side component has an opening therein providing access to the document recess.

According to another embodiment, the document tray has a flap extending from the backer member. The flap is adapted to removably connect the document tray to a support member.

According to another embodiment, a first frame holder is provided adjacent a first surface of the backer member and a second frame holder is provided adjacent a second surface of the backer member. In this embodiment separate documents can be stored on opposing sides of the document tray.

According to another embodiment, the document tray has a hinge in the backer member to allow the document tray to be folded.

According to another embodiment, the document tray has an engaging member extending from the backer member, the grasper member adapted to engage a retainer in a cavity of a notebook to allow the document tray to transition from a first position to a second position.

According to another embodiment, the document tray has a generally planar and substantially rigid backer member, a first frame holder member at a first corner and connected to the backer member, a second frame holder member at a second corner and connected to the backer member, a third frame holder member at a third corner and connected to the backer member, and a fourth frame holder member at a fourth corner and connected to the backer member. Each of the frame holder members has a portion spaced from and generally parallel to the backer member.

According to another embodiment, the document tray comprises a sliding document tray for use with a notebook having a first section and a second section, wherein the second section has a cavity. The document tray comprises a generally planar rigid backer member, a frame holder connected to the backer member to define a document recess, and an engaging member extending from the document tray. The backer member is moveable from a first position generally within the cavity of the notebook to a second position wherein a majority of the document tray is outside the cavity of the notebook. The engaging member engages a portion of the notebook in the second position to prevent the document tray from extension past the second position.

According to yet another embodiment, the sliding document tray assembly also has a second document tray. The second document tray is moveable from a first position generally within the cavity of the notebook to a second position wherein a majority of the second document tray is outside the cavity of the notebook. The engaging member engages a portion of the notebook in the second position to prevent the second document tray from extension past the second position.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a top view of one embodiment of a document tray used in connection with a folder;

FIG. 2 is a top view of another embodiment of a document tray;

FIG. 3 is a cross-sectional view about lines 3-3 of FIG. 2;

FIG. 4 is a top view of a two-sided hinged document tray used in connection with a folder;

FIG. 5 is a cross-sectional view about line 5-5 of FIG. 4;

FIG. 6 is a top view of another embodiment of a foldable document tray;

FIG. 7 is a cross-sectional view about line 7-7 of FIG. 6;

FIG. 8 is a perspective view of another embodiment of a document tray having a flap and used in combination with a modular deskpad system;

FIG. 9 is a perspective view of another embodiment of a sliding document tray used with a folder (with cutout);

FIG. 10 is a top view of another embodiment of a dual sliding document tray system used with a folder; and,

FIG. 11 is an exploded view of the document tray system of FIG. 10.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

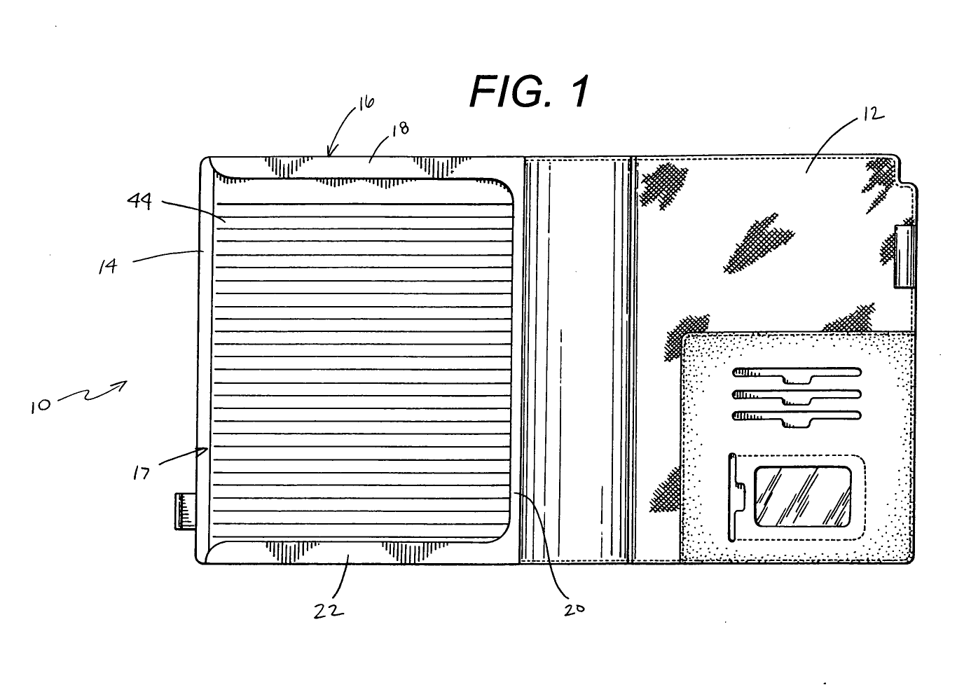

Referring now to the Figures, and specifically to FIG. 1, there is shown a document tray 10. In this embodiment, the document tray 10 is used in combination with a binder or planner system 12. The document tray 10 generally comprises a generally planar rigid backer member 14 and a frame holder 16 connected to the backer member 14.

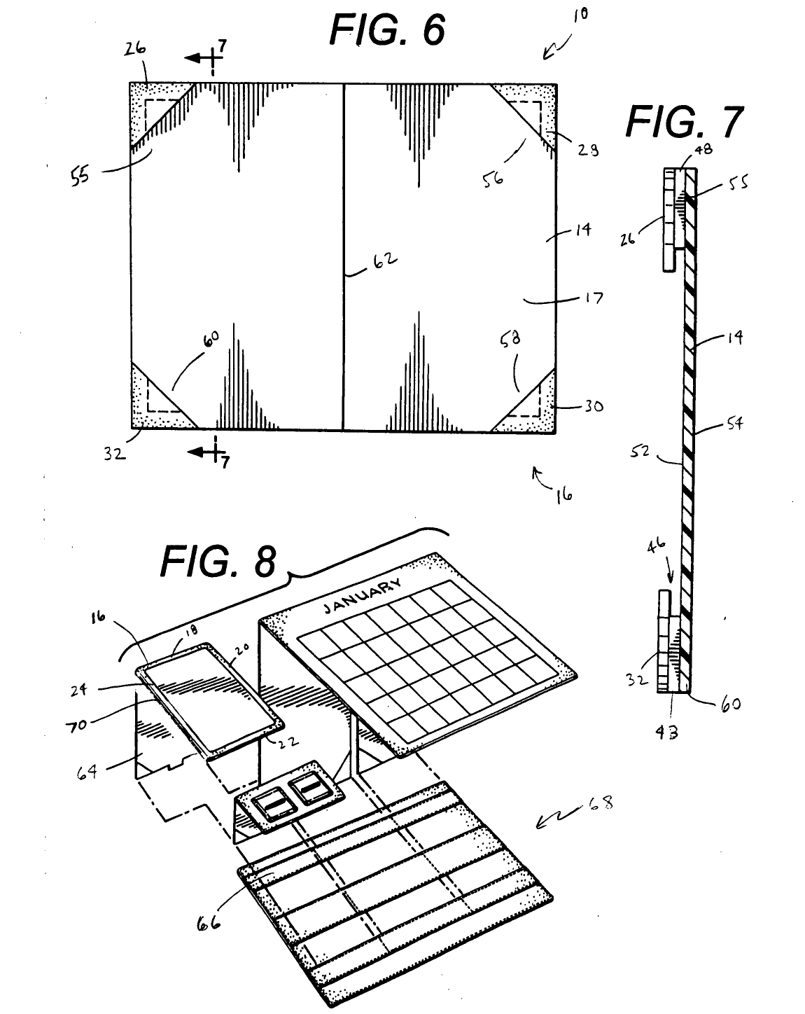

In this first embodiment, as shown in FIG. 1, the frame holder 16 has a first side component 18, a second side component 20, and a third side component 22. The second side component 20 opposes the first side component 18, and the third side component 22 is provided between the first side component 18 and the second side component 20. In a second embodiment, as shown in FIG. 8, the frame holder 16 further has a fourth side component 24. The fourth side component 24 is positioned between the first side component 18 and the second side component 20, opposing the third side component 22. In a third embodiment, the as shown in FIG. 6, the frame holder 16 comprises a first frame holder member 26, a second frame holder member 28, a third frame holder member 30 and a fourth frame holder member 32. The first frame holder member 26 is provided at a first corner, the second frame holder member 28 is provided at a second corner, the third frame holder member 30 is provided at a third corner and the fourth frame holder member 32 is provided at a fourth corner. The document frame 16 defines a document recess 17 for holding and providing access to documents 44 in the document recess. Additional embodiments of the document tray 10, such as an embodiment utilizing only the first side component 18 and the second side component 20, and embodiments utilizing only portions of the side components, also come within the scope of the claims.

Referring now to FIGS. 1-3, one embodiment of the document tray 10 is shown. This embodiment of the document tray 10 comprises a backer member 14 and a frame holder 16 connected to the backer member 14. The frame holder 16 has a first side component 18, a second side component 20, and a third side component 22. As such, this embodiment has an opening opposing the second side component 20 (i.e., where the fourth side component would be placed if this embodiment had a fourth side component) and is thus referred to as a three-sided frame holder 16.

The backer member 14 is generally planar and rigid and has a first side 36, a second side 38 opposing the first side 36, a third side 40 between the first side 36 and the second side 38, and a fourth side 42 opposing the third side 40 and located between the first side 36 and the second side 38. In a preferred embodiment, the backer member 14 is made of a rigid plastic and provides a base to support one or more pieces of paper 44 and to allow the user to write on the paper 44 being held in the document tray 10. In this embodiment document tray 10 is an integral component fixed to the binder 12. Accordingly, the backer member 14 may either comprise a portion of the folder or binder 12, such as interior cover of the folder 12, or it may be a separate component fixed to the folder or binder 12, such as by having a rear surface of the backer member 14 fixed to the binder 12.

The frame holder 16 generally provides a support for retaining the paper 44 in the document tray 10. The frame holder 16 overlaps a portion of the paper 44 at the edges thereof to support the paper 44, but also to provide a majority of the paper 44 open and free from restraint to allow the user to write on the paper 44 when it is in the frame holder 16.

As best shown in FIG. 3, a portion of the frame holder 16 is positioned in a plane generally parallel to the backer member 14. Additionally, in a preferred embodiment that portion of the frame holder 16 is spaced a distance from the backer member 14 to provide a recess 46 for receiving and retaining the paper 44.

In one embodiment, a spacer 48 is provided between the backer member 14 and the frame holder 16. The spacer 48 is utilized to space a portion of the frame holder 16 a distance from the backer member 14. This distance generally defines the cavity or recess 46 for retaining the paper 44 between the backer member 14 and the frame holder 16. In a preferred embodiment a spacer 48 is associated with each component of the frame holder 16. In an alternate embodiment the side components of the frame holder have an integral spacer and thus a separate member is not needed.

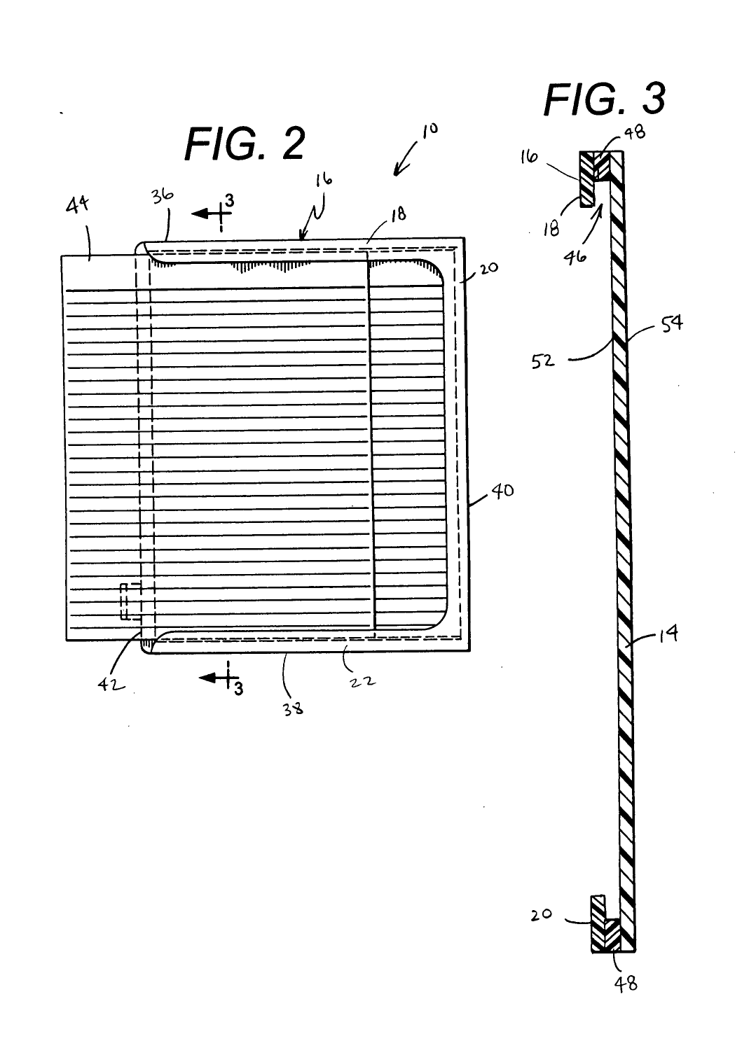

Thus, in this three-sided frame holder embodiment of the document tray 10, the paper 44 is slid into position through the opening 50 in the frame holder 16 (as shown in FIG. 2) and is retained at its edges by the first, second and third side components 18, 20, 22 of the frame holder 16 (as shown in FIG. 3). In its retained position, the user is free to write on virtually all of the paper except for the edges being retained by the frame holder 16.

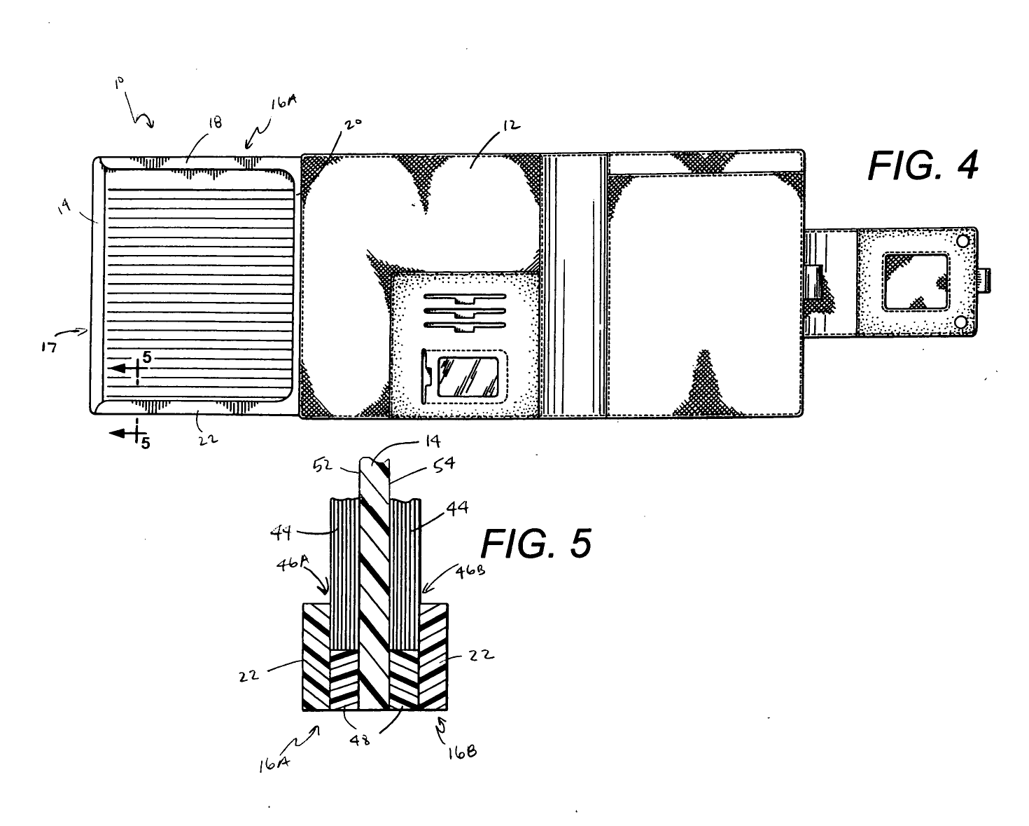

A second embodiment of the document tray 10 is shown in FIGS. 4 and 5. In this embodiment the document tray 10 is referred to as a dual-sided document tray 10. Accordingly, in this embodiment the document tray 10 has a first frame member 16A adjacent a first surface 52 of the backer member 14, and a second frame member 16B adjacent a second surface 54 of the backer member 14. As with the first frame holder 16A, the second frame holder 16B has a first side component 18, a second side component 20, and a third side component 22. As such, this embodiment also has an opening opposing the second side component 20 (i.e., where the fourth side component would be placed if this embodiment had a fourth side component) and is thus referred to as a three-sided frame holder 16. Alternatively, a four-sided frame holder 16 or a frame holder of another configuration may be provided. The second frame holder 16B generally provides a support for retaining the paper 44 in the document tray 10. As best shown in FIG. 5, a portion of the first and second frame holders 16A and 16B is positioned in a plane generally parallel to the backer member 14. Additionally, in a preferred embodiment that portion of the first and second frame holders 16A and 16B are spaced a distance from the backer member 14 to provide a recess 46 for receiving and retaining the paper 44. In this embodiment wherein two frame holders are provided, a spacer 48 is utilized between each frame holder 16A and 16B and the opposing surfaces 52, 54 of the backer member 14 to create a first cavity or recess 46A between the first surface 52 of the backer member 14 and the first frame holder 16A, and a second cavity or recess 46B between the second surface 54 of the backer member 14 and the second frame holder 16B.

Additionally, in this embodiment the document tray 10 is hingedly connected to the folder 12 adjacent the second side 38 of the backer member 14. Accordingly, the document tray 10 is able to be hinged to be positioned over the inside cover of the folder 12 for storage and for viewing of the various documents 44 in the first and second frame holders 16A, 16B of the document tray 10.

Another embodiment of the document tray 10 is provided in FIGS. 6 and 7. In this embodiment the frame holder 16 comprises a first frame holder member 26, a second frame holder member 28, a third frame holder member 30 and a fourth frame holder member 32. Each of the frame holder members 26, 28, 30 and 32 are connected to a surface of the backer member 14. In a preferred embodiment, the first frame holder member 26 is provided at a first corner 54 of the backer member 14, the second frame holder member 28 is provided at a second corner 56 of the backer member 14, the third frame holder member 30 is provided at a third corner 58 of the backer member 14, and the fourth frame holder member 32 is provided at a fourth corner 60 of the backer member 14.

As shown in FIG. 7, like the frame holders 16 of the prior embodiments, the frame holder members 26, 28, 30 and 32 of this embodiment have a portion positioned in a plane generally parallel to and spaced a distance from the backer member 14 to provide a recess 46 between each holder member and the backer member 14 for receiving and retaining documents at the corners of the documents, thereby leaving the remaining portions of the documents accessible for viewing the documents and for writing on the documents. It is understood that as in one of the embodiments described and illustrated herein, this embodiment may also have frame holder members on the second side of the backer member 14 to provide for holding documents on both sides of the document tray 10.

Referring to FIG. 6, in one embodiment the backer member 14 has a hinge 62. In such an embodiment with a hinge 62 in the backer member 14, the document tray 10 is able to be folded in half for transport and storage.

Another embodiment of the document tray 10 is shown in FIG. 8. In this embodiment the document tray 10 has a flap 64 extending from the backer member 14. The flap 64 is adapted to allow the document tray 10 to be removably connected to a support member 66 in a variety of positions in a modular desk pad 68. Additionally, in the document tray 10 of this embodiment, the frame holder 16 further has a fourth side component 24. The fourth side component 24 is positioned between the first side component 18 and the second side component 20, opposing the third side component 22, on the backer member 14. Like the other side components of the frame holder 16, a portion of the fourth side component 24 is positioned in a plane generally parallel to the backer member 14, as well as being spaced a distance from the backer member 14 with a spacer to provide a recess 46 for receiving and retaining the paper 44.

Further, a portion of the frame holder 16 in this embodiment preferably has an opening 70 to allow a document 44 to be slid in and out of the document recess 17. In one embodiment the spacer 48 associated with one of the side components of the frame holder 16 is eliminated, thereby creating the opening 70 between the side component and the backer member 14. In this embodiment, the spacer 48 associated with the fourth side component 24 has been eliminated to create the opening 70. In an alternate embodiment, the opening 70 is provided in one of the components of the frame holder 16.

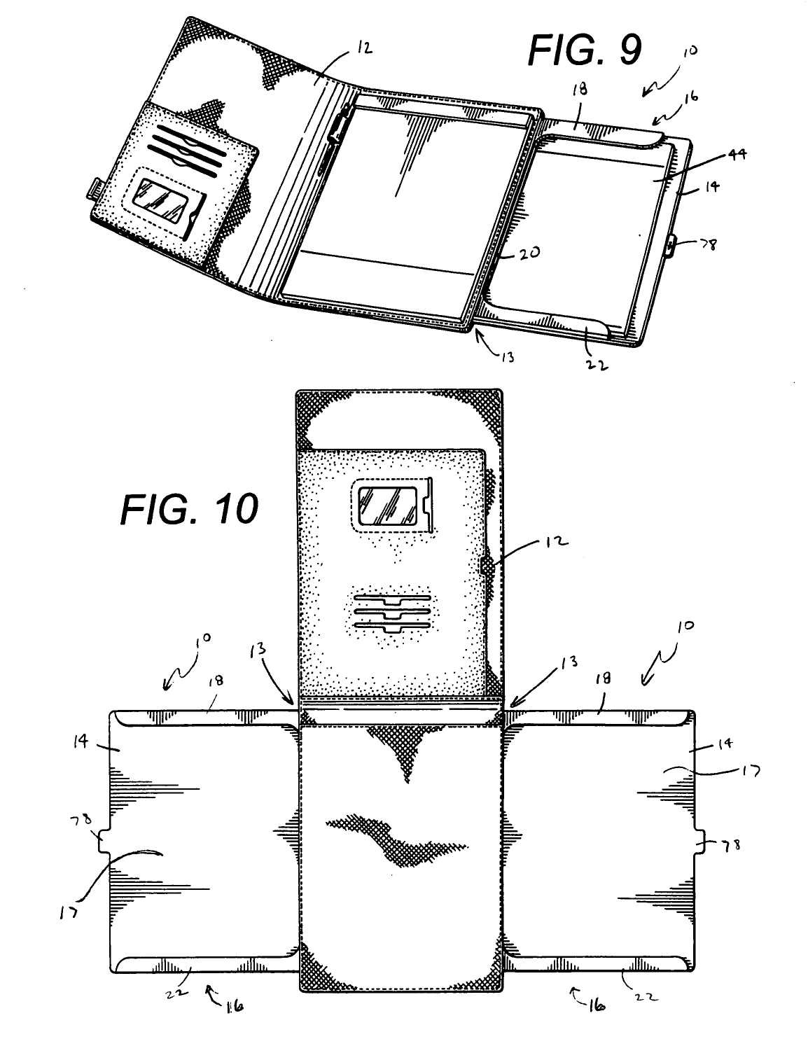

Additional embodiments of the document tray 10 are shown in FIGS. 9-11. In these embodiments the document tray 10 is a sliding document tray used with a notebook 12. The document tray 10 slides in and out of a cavity 13 in the notebook 12, and preferably in and out of a cavity 13 in one of the covers (front or back) of the notebook 12. Referring to the embodiment of FIG. 9, the notebook 12 has a front and back cover, also referred to as a first and second section, and the document tray 10 slides in and out of the rear cover of the notebook 12. In the embodiment of FIG. 10, two document trays 10 slid in and out of opposing sides of the cover of the notebook 12. Preferably, stops are provided to prevent the document tray 10 from coming completely out of the cavity 13 of the notebook 12 and becoming displaced therefrom. Instead, in the preferred version of this embodiment the document tray 10 can slide out to a position whereby the entire document recess 17 is accessible and visible to view the entire contents of any writing on the document 44 in the document recess 17. Accordingly, in a preferred embodiment the document tray 10 is moveable between a first position, wherein the document tray 10 is stowed entirely within the cavity 13 of the notebook 12, and a second position, as shown in FIGS. 9 and 10, wherein the document tray 10 and any documents retained thereby are discharged from the cavity 13 and accessible.

In both of these embodiments the document tray 10 has a generally planar rigid backer member 14, and a frame holder 16 connected to the backer member 14 to define a document recess 17. The frame holder 16 preferably has a plurality of frame portions with a portion thereof 18, 20 and 22 positioned generally parallel to and spaced a distance from the backer member 14.

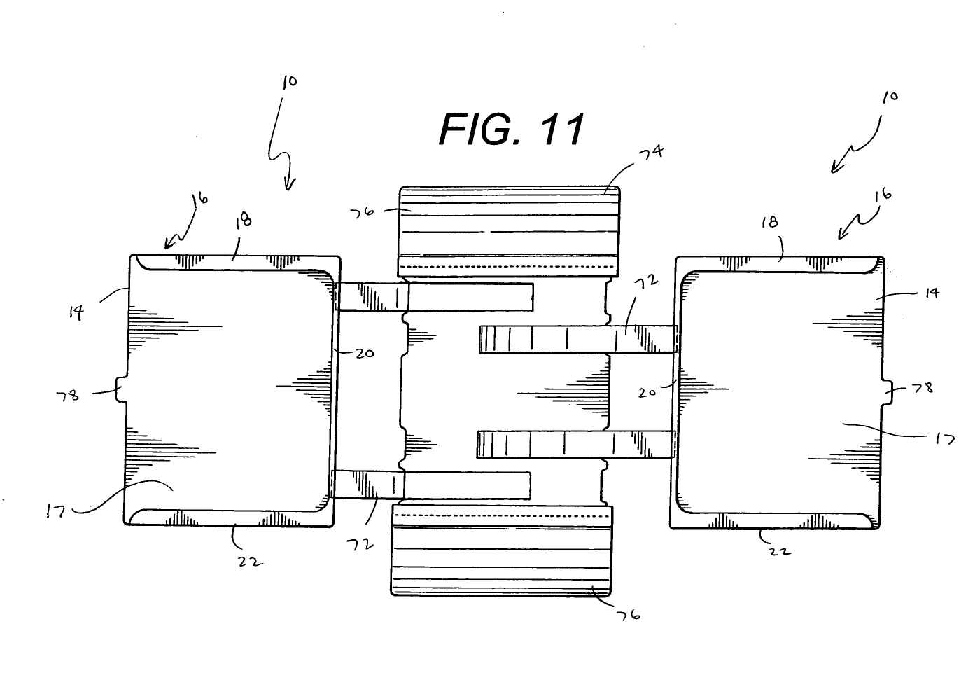

The document tray 10 also has an engaging member 72 extending from the document tray 10. The engaging member 72 is used to engage a portion of the notebook 12 (generally an interior component such as a retainer 74 within the cavity 13 of the notebook 12) in the second position to prevent the document tray 10 from extension past the second position. In one embodiment, as shown in FIG. 11, the engaging member 72 comprises a strap 72 extending from the backer member 14 of the document tray 10. And, in a preferred embodiment two straps 72 are provided for each sliding document tray 10. It is understood, however, that the engaging member 72 may comprise different components other than a strap. For example, a grasper member that extends from the backer member 14 may be utilized to prevent the document tray 10 from extending past the second position defined above. The grasper member is generally adapted to engage a retainer in the cavity 13 of the notebook 12 to allow the document tray 10 to transition from the first position to the second position, but generally not further than the second position.

In one embodiment, the retainer 74 of the notebook 12 is fitted within the cavity 13 of the notebook 12. In a preferred embodiment the retainer 74 is a sleeve within the cavity 13 that the straps 72 engage. The wings 76 are shown in the expanded position in FIG. 11. The wings 76 fold down over the body of the retainer 74 to form a channel. The document tray 10 is adapted to slide within the channel of the retainer 74. The engaging straps 72 are provided around the body of the retainer 74, and the engaging straps 72 are sized such that when the document tray 10 is pulled outwardly, typically with a tab 78 extending from the backer member 14, the document tray 10 can slide until the engaging straps 72 prevent further movement of the document tray 10. The position wherein the document tray 10 is prevented from further movement out of the cavity 13 has been referred to above as the second position. At this position the straps 72 are tight, preventing further outward movement of the document tray 10. For exemplar purposes only, FIG. 11 illustrates the document trays 10 with the straps 72 not fully assembled on the retainer 74. Specifically, in this not fully assembled position the straps 72 of the document trays 10 are not fully seated around the body of the retainer 74. After complete assembly, however, in one embodiment the straps 72 would extend in a loop around the body of the retainer 74.

Referring to FIGS. 10 and 11, two sliding document trays 10 may be provided, one document tray 10 extending from one side of the notebook 12 and another document tray extending from the other side of the notebook 12. These document trays 10 operate independently, and as such, movement of one document tray 10 is completely independent of movement of the other document tray 10.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and claims, is utilized in an open-ended manner.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention and the scope of protection is only limited by the scope of the accompanying Claims.

What is claimed is:

1. A document tray to retain a writing surface and provide for annotation over a majority of the writing surface, comprising:
a generally planar rigid backer member, and a frame holder connected to the backer member, the frame holder having a first side component, a second side component opposing the first side component, and a third side component between the first side component and the second side component, wherein a portion of the frame holder is positioned in a plane generally parallel to the backer member to define a document recess.

2. The document tray of claim 1, wherein the portion of the frame holder that is positioned in a plane generally parallel to the backer member is also spaced a distance from the backer member.

3. The document tray of claim 1, further comprising a spacer between the backer member and the frame holder to space a portion of the frame holder a distance from the backer member, thereby creating a cavity between the backer member and the frame holder.

4. The document tray of claim 1, further comprising a cavity between the backer member and the frame holder.

5. The document tray of claim 1, wherein the frame holder further comprises a fourth side component opposing the third side component, the fourth side component further being between the first side component and the second side component.

6. The document tray of claim 5, wherein the fourth side component has an opening therein providing access to the document recess.

7. The document tray of claim 1, wherein the first side component, second side component and third side component form a three-sided frame holder.

8. The document tray of claim 1, wherein a rear surface of the backer member is connected to a cover of a folder.

9. The document tray of claim 1, wherein the backer member comprises a cover of a folder.

10. The document tray of claim 1, further comprising a flap extending from the backer member, the flap adapted to removably connect the document tray to a support member.

11. The document tray of claim 1, wherein the frame holder is provided adjacent a first surface of the backer member, and further comprising a second frame holder adjacent a second surface of the backer member, the second frame holder having a first side component, a second side component opposing the first side component, and a third side component between the first side component and the second side component, wherein a portion of the second frame holder is positioned in a plane generally parallel to the second surface of the backer member to define a second document recess frame.

12. The document tray of claim 1, further comprising a hinge in the backer member to allow the document tray to be folded.

13. The document tray of claim 1, further comprising a grasper member extending from the backer member, the grasper member adapted to engage a retainer in a cavity of a notebook to allow the document tray to transition from a first position to a second position.

14. A document tray comprising: a generally planar rigid backer member, a first frame holder member at a first corner and connected to the backer member, a second frame holder member at a second corner and connected to the backer member, a third frame holder member at a third corner and connected to the backer member, and a fourth frame holder member at a fourth corner and connected to the backer member, each of the frame holder members having a portion spaced from and generally parallel to the backer member.

15. The document tray of claim 14, further comprising a flap extending from the backer member, the flap adapted to removably connect the document tray to a support member.

16. The document tray of claim 14, further comprising a hinge in the backer member to allow the document tray to be folded.

17. The document tray of claim 14, further comprising a fifth frame holder member connected at a first corner of a second surface of the backer member, a sixth frame holder member connected at a second corner of the second surface of the backer member, a seventh frame holder member connected at a third corner of the second surface of the backer member, and an eighth frame holder member connected at a fourth corner of the second surface of the backer member.

18. A sliding document tray assembly for use with a notebook, the notebook having a first section and a second section, the second section having a cavity, the document tray assembly comprising:
a generally planar rigid backer member;
a frame holder connected to the backer member to define a document recess, the frame holder having a plurality of frame portions with a portion thereof positioned generally parallel to and spaced a distance from the backer member; and,
an engaging member extending from the document tray, wherein the backer member is moveable from a first position generally within the cavity of the notebook, to a second position wherein a majority of the document tray is outside the cavity of the notebook, the engaging member engaging a portion of the notebook in the second position to prevent the document tray from extension past the second position.

19. The sliding document tray assembly of claim 18, further comprising a second document tray having a second generally planar rigid backer member and a frame holder connected thereto to define a document recess, the second document tray also having an engaging member extending from the second backer member, wherein the second document tray is moveable from a first position generally within the cavity of the notebook, to a second position wherein a majority of the second document tray is outside the cavity of the notebook, the engaging member engaging a portion of the notebook in the second position to prevent the second document tray from extension past the second position.

20. The sliding document tray assembly of claim 18, wherein the engaging member comprises a strap extending from the backer member.

21. The sliding document tray assembly of claim 20, wherein the engaging member engages a retainer inside the cavity of the notebook.

22. The sliding document tray assembly of claim 18, wherein the frame holder further comprises a first side component, a second side component opposing the first side component, and a third side component between the first side component and the second side component, a portion of the first, second and third side components being positioned generally parallel to the backer member and spaced a distance from the backer member.

23. The sliding document tray assembly of claim 22, further comprising a fourth side component opposing the third side component, the fourth side component further being between the first side component and the second side component, and the fourth side component having an opening therein providing access to the document recess.

24. The sliding document tray assembly of claim 18, wherein the frame holder further comprises a first frame holder member at a first corner and connected to the backer member, a second frame holder member at a second corner and connected to the backer member, a third frame holder member at a third corner and connected to the backer member, and a fourth frame holder member at a fourth corner and connected to the backer member, each of the frame holder members having a portion spaced from and generally parallel to the backer member.
